(19) United States
(12) Patent Application Publication
(10) Pub. No.: US 2023/0182500 A1
(43) Pub. Date: Jun. 15, 2023

(54) A CONTINUOUS LAYOUT RANDOM PHASE TILE AND METHOD THEREOF

(71) Applicant: REY CERA CREATION PRIVATE LIMITED, Morbi (IN)

(72) Inventor: Rasik R. DETROJA, Morbi (IN)

(73) Assignee: REY CERA CREATION PRIVATE LIMITED, Morbi (IN)

(21) Appl. No.: 17/926,432

(22) PCT Filed: Apr. 7, 2022
(86) PCT No.: PCT/IN2022/050337

§ 371 Date: Nov. 18, 2022

(30) Foreign Application Priority Data
Apr. 19, 2021 (IN) 202121018037

(51) Int. Cl. B44C 5/04; E04F 15/08

(52) U.S. Cl. CPC B44C 5/04; E04F 15/08; B44F 9/04

(57) ABSTRACT

The present invention relates to the field of tile printing. More particularly, it relates to designing random phases for continuous layout ceramic tile applications. The present invention further provides a method [200] for producing a continuous design layout comprising of random faced tiles with joint free pattern of a tile comprising creating [103] prints or design on horizontal and vertical ends of a subset of workpiece obtaining joint free workpiece with random faces and creating [104] design on the middle or center part of each random phase/face. Advantageously the present invention relates to a joint free tile to make easy inventor management in ceramic industry and the final product looks aesthetically very superior.

### FIELD OF THE INVENTION

The present invention relates to the field of tile printing. More particularly, it relates to designing random phases for continuous layout ceramic tile applications. The present invention further provides a method for producing a continuous design layout comprising of random faced tiles with joint free pattern of the tile.

### BACKGROUND OF THE INVENTION

Market trend in tile design was designing and marketing random phases of marble, textures and wood. Random phases look good individually but sometimes look very odd after laid out. To make a tile design continuous, phases had to be designed and laid in a set pattern. The set pattern requires a lot of inventory management. Inventory management in a ceramic industry is a big problem and because of the same a lot of dead stock was generated.

Random phase's designs were prevalent in the tile industry. All the designs in the ceramic industry prior to our continuous marble were randomly printed which affected the aesthetics of the final product. Design in a set pattern creates inventory problem and in turn creates dead stock.

The initial designs had a single face. All designs had a single face and were not joint free or continuous. We aimed to make the single face design continuous. We successfully achieved the same but the final product had a lot of repetition because of the design being single faced.

The next step was, we created designs with multiple faces. This faces were all random and the final carpet which is formed after laid looks all disjointed. That is the observer can make out the size of the tile laid from one tile to the next.

JPH08209894A relates to a tile set having rag-stone pattern and packing case therefor. PURPOSE: To increase efficiency in construction work by sticking/arranging plural kinds of regular shape tile pieces to/on a layout sheet having a prescribed shape by mutually arranging joint parts, forming a tile set having a rag-stone pattern, and performing construction work by arranging this set in a continuous row shape. CONSTITUTION: Plural kinds of regular shape tile pieces A to G are stuck on a layout sheet of a quadrangle, a pentagon, a hexagon or the like by mutually arranging joint parts by referring to an allocation drawing, and a tile set having a rag-stone pattern is formed. A construction work display line being a diagonal line of respective polygons is printed on the layout sheet, and it is used as a standard of an arranging angle when the tile set is arranged in a continuous row shape in large numbers. On the other hand, a packing case in which regular shape tile pieces can be housed with every kind in a vertically placing condition is provided, and damage or the like is prevented from being caused at transport time. The tile set having a rag-stone pattern is arranged in a continuous row shape on a floor surface and a wall surface or the like. Therefore, field work is simplified, and construction work can be efficiently performed.

KR20100090913A relates to a printed tile for decoration of bottom with non-bond. PURPOSE: A printed tile for decorating a prefabricated bottom is provided to easily perform a maintenance work by easily assembling and disassembling the tiles and to improve workability and construction performance. CONSTITUTION: A printed tile for decorating a prefabricated bottom is composed as follows. A design printed sheet is attached on the upper surface of the tile. Fitting protrusions and fitting grooves are formed in all sides of the tile. The inner and outer surfaces in which the fitting protrusions and the fitting grooves are coupled are inclined. A square pyramid shaped groove is formed on the lower surface of the tile. The printed tile is made of PVC, stone powder, and nano-silver.

EP1873327B1 relates to a method for laying tiles seamlessly. The covering panel has a lower side running in distance to an upper side, and an edge zone connecting the upper and the lower sides. The edge zone has a surface section with a flat upper surface, which is designed for jointless attachment at the corresponding covering panel. Another surface section has an upper surface in which a groove shaped recess extends, and forms a channel section that runs parallel to the upper side of the panel.

The former surface section runs perpendicularly to the upper side. An independent claim is also included for a method for displacement of a slab lining with a covering panel.

Hence, there is a need for a method to create designs with random faces but they must be continuous after being laid.

### OBJECTS OF INVENTION

It is main object of the present invention to provide a continuous design layout comprising of random faced tiles.

It is another object of the present invention to provide a joint free pattern of the tile.

It is yet another object of the present invention to provide aesthetically superior tile layout as it becomes joint free.

It is still another object of the present invention to make easy inventor management in ceramic industry and the final product looks aesthetically very superior.

It is another object of the present invention to give a tile layout irrespective of the number of phases the final product remains joint free.

It is another object of the present invention to create an aesthetically beautiful product which gets close to naturally occurring marble as possible.

It is another object of the present invention to provide a method for producing a continuous design layout comprising of random faced tiles with joint free pattern of the tile.

### SUMMARY OF THE INVENTION

One or more of the problems of the conventional prior art may be overcome by various embodiments of the present invention.

It is the primary aspect of the present invention to provide a method of printing continuous layout random phase tiles, comprising:

Obtaining predetermined size of the carpet piece;

Obtaining subset of the original carpet piece;

Wherein the subset comprises of predetermined dimensions;

Creating one or more faces from the subset carpet;

Creating prints or design on the horizontal and vertical ends of the subset of workpiece for obtaining joint free workpiece with random faces; and creating design on the middle or centre part of each random phase/face,

Wherein the printed workpiece comprises of an indicator mark at the rear side, and the printed workpieces are laid out uni-directionally as per an indicator mark to obtain joint fee or continuous faces in the layout.

It is another aspect of the present invention to provide a method of printing continuous layout random phase tiles, wherein the workpieces are printed/designed such that the ends of the workpiece movie both horizontally and vertically in such a way that irrespective of the orientation of the faces; as long as the arrow on the back side of the workpiece is followed both the faces become joint free.

It is another aspect of the present invention to provide a method of printing continuous layout random phase tiles, wherein each face of the workpiece is designed to match continuously with face of another workpiece laid unidirectional as per the indicator mark.

It is another aspect of the present invention to provide a method of printing continuous layout random phase tiles, wherein the product looks like a homogenous single piece.

It is another aspect of the present invention to provide a method of printing continuous layout random phase tiles, wherein the final product is continuously pattered with each carpet comprising random faces.

It is another aspect of the present invention to provide method of printing continuous layout random phase tiles, wherein the ceramic is selected from HSNCODE: 69072100, HSN CODE 69072300 and the like.

It is another aspect of the present invention to provide a method of printing continuous layout random phase tiles, wherein the workpiece is selected from marbles, tiles and the like.

### BRIEF DESCRIPTION OF THE DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawing, which form a part of this specification. It is to be noted, however, that the drawing illustrates only a preferred embodiment of the invention and is therefore not to be considered limiting of the invention's scope as it may admit to other equally effective embodiments.

FIG. 1 illustrates the single face of “Royal satvario”.

FIG. 2 illustrates the single face “joint free royal satvario”

FIG. 3 illustrates the two faces of “Royal satvario” designed in a book match pattern.

FIG. 4 illustrates the four faces of “Royal satvario” designed in an “endless marble” concept according to the present invention.

FIG. 5 illustrates the flowchart of a method of printing continuous layout random phase tiles according to the present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The present invention relates to the field of tile printing. More particularly, it relates to designing random phases for continuous layout ceramic tile applications. The present invention further provides a method for producing a continuous design layout comprising of random faced tiles with joint free pattern of the tile. The printed tiles are laid out uni-directionally as per the indicator mark to obtain joint free or continuous faces in the layout.

### History of ‘Rey cera’ designing in Ceramic Industry

Naturally occurring marbles are recreated in digital form for commercial applications. Digital files of recreated natural marbles are used on digital platforms like Adobe Photoshop or coral draw for further designing process.

Ceramic color profiles are applied on digital files. Color profile is basically a digital file. A color degradation chart is printed on a ceramic tile and fired. The color intensity gamut on the degradation chart is extracted and saved in a digital format. This file is called Color profile. It has the color intensity information as per the ceramic tile production parameters. The Color profile basically limits the color gamut as per the ceramic industry parameters.

The software which manufacturer use is Adobe Photoshop/Coral draw with the required tools for design editing. The manufacturer matches the color of the designs as per user requirement.

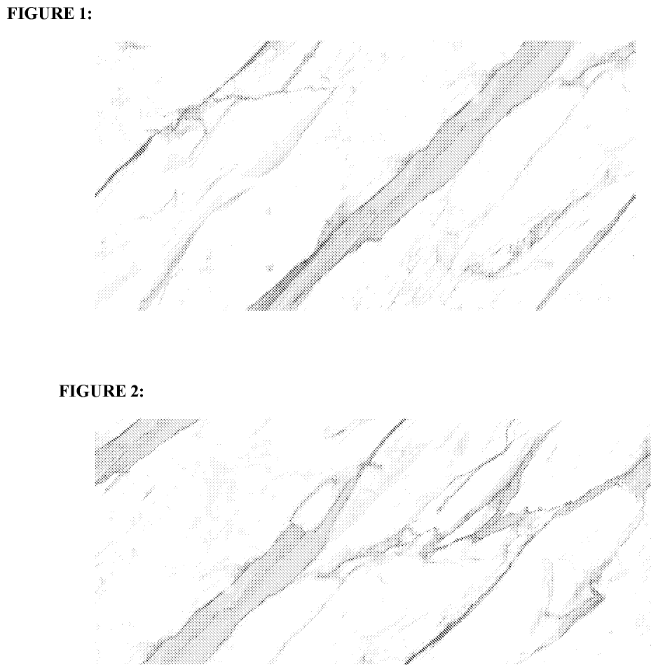

Referring to FIG. 1, the single face of “Royal satvario” is illustrated. The initial designs had a single face. All designs had a single face and are not joint free or continuous. Rey cera have taken one of the designs called ‘ROYAL SATVARIO’ as reference (FIG. 1).

Joint Free: When any design is made joint free, the following steps are followed. The design carpet is selected as per user requirement keeping in mind the essence of the original marble. The best part of the carpet is selected and the edges of the design are designed in such a way that when the same face is repeated along the lengths or the breath of the design, the design will remain continuous. It does not cut or look disjointed.

The second step was making the single face design continuous. Rey cera successfully achieved the same but the final product had a lot of repetition because of the design being single faced.

Referring to FIG. 2, the single face “joint free royal satvario” is illustrated. The next step was, Rey cera created designs with multiple faces. These faces were all random and the final carpet which is formed after laid looks all disjointed. That is you can make out the size of the tile laid when you go from one tile to the next.

So the obvious next step which came to Rey cera mind was to create designs with random faces but they must be continuous after being laid.

But this was a difficult thing to do. Rey cera partly succeeded when the manufacturer came up with a concept called Book-Match.

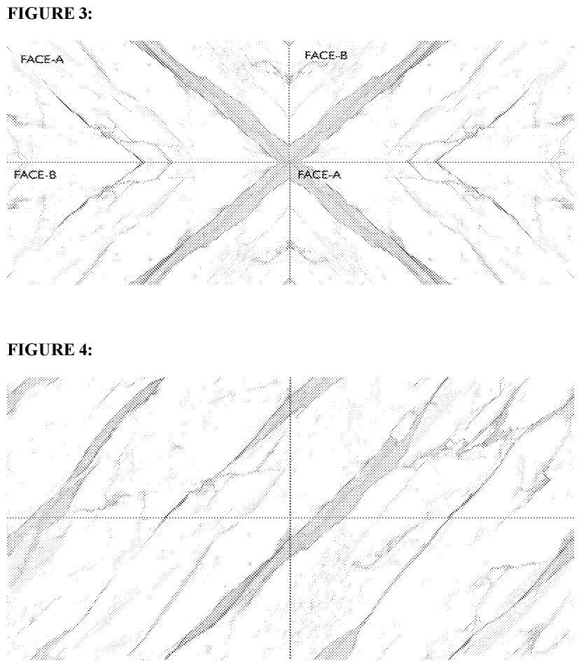

Book Match: Book match is a design which has a set of 2 faces. FACE A and FACE B. These two faces have to be laid in an alternating pattern to form a continuous carpet. Referring to FIG. 3, the two faces of “Royal satvario” designed in a book match pattern is illustrated. FACE A and FACE B are laid side by side and then the same faces are alternated and laid, FACE A-FACE B-FACE A-FACE B, to form a design which is known as BOOK MATCH.

But again there is a limitation in designing BOOK match products. The essence of the final design is almost similar in all designs. Also taking commercial production and inventory management is very difficult. FACE A and FACE B have to be maintained in fixed quantities. They have to be maintained in same batch as well. If a single face is lost during transportation or handling the other face become redundant automatically.

In the aim to continuously innovate, Rey cera are always finding new methods to solve the existing problems and develop better products. Rey cera have been pioneer in all the innovations which has been explained above and have always strived to find superior products then we have always provided.

The evolution of designing and the thought process which Rey cera followed is explained above. Finally Rey cera came up with ‘ENDLESS MARBLE’ concept.

### The Main Aspects of the Present Invention

### The Definition of ‘ENDLESS MARBLE’:

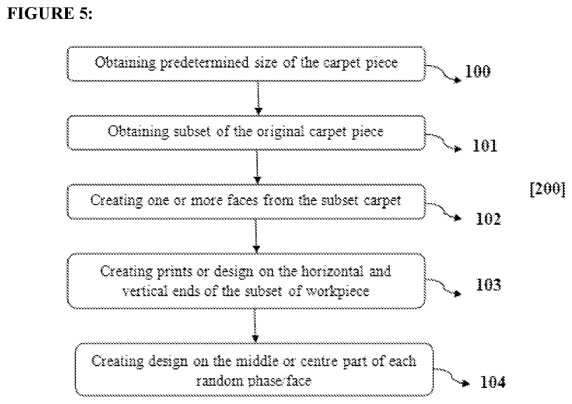

Referring to FIG. 4, the four faces of “Royal satvario” designed in an “endless marble” concept according to the present invention is illustrated. Rey cera have a thought process of designing a naturally recreated marble. It has multiple random faces. But after laying each and every random face, the random face joints with the next random face irrespective of laying it horizontally or vertically. You have to lay it in a unidirectional way. By unidirectional we mean one has to just follow the arrow behind the respective tile and keep on laying the tiles in a single direction. We call it ‘ENDLESS MARBLE’.

Referring to FIG. 5, the flowchart of a method of printing continuous layout random phase tiles is illustrated. A method [200] of printing continuous layout random phase tiles, comprising of steps:

obtaining [100] predetermined size of the carpet piece;

obtaining [101] subset of the original carpet piece;

the subset comprises of predetermined dimensions;

creating [102] one or more faces from the subset carpet;

creating [103] prints or design on the horizontal and vertical ends of the subset of workpiece for obtaining joint free workpiece with random faces; and

creating [104] design on the middle or centre part of each random phase/face, the printed workpiece comprises of an indicator mark at the rear side, and the printed workpieces are laid out uni-directionally as per an indicator mark to obtain joint free or continuous faces in the layout.

The workpieces are printed/designed such that the ends of the workpiece move both horizontally and vertically in such a way that irrespective of the orientation of the faces, as long as the arrow on the back side of the workpiece is followed both the faces become joint free. Each face of the workpiece is designed to match continuously with face of another workpiece laid unidirectional as per the indicator mark. The product looks like a homogenous single piece. The final product is continuously patterned with each carpet comprising random faces. The ceramic is selected from HSNCODE: 69072100, HSN CODE 69072300 and the like. The workpiece is selected from marbles, tiles and the like.

### The Process

Initially the full carpet is taken. The desired size out of the carpet is selected. Suppose we have a carpet of size 1500 mm×3000 mm and we need to develop 4 faces in the size of 600 mm×1200 mm. So the carpet size which needs to be selected from the original carpet is 1200 mm×2400 mm. Now we can develop 4 faces from the subset carpet. Also we take into consideration the naturality of the original carpet when taking a subset out of it. The four faces are developed in mind keeping the original essence of the marble.

We first take a single face and then make it joint free. After we make the first face joint free we move on to the second face. We now design these two faces simultaneously. Keeping in mind the essence of the original marble we start designing the two faces as a continuous joint free marble. Firstly we design the ends of the marble both horizontally and vertically in such a way that irrespective of the orientation of the faces, as long as the arrow on the back side of the tile is followed both the faces become joint free.

After the ends are designed and the two faces become joint free, the middle part of each face is designed to maintain the essence of the original natural marble.

So we have achieved 2 random faced continuous marble. But in our final product implementation we have minimum of 4 random faces.

So we move on to the 3rd face and repeat the same process which we did when we took the 2nd face. We now design these three faces simultaneously. We start designing the three faces as a continuous joint free marble. We take each face and design the ends of it in such a way that irrespective of the choice and orientation of the faces they form a single continuous marble only. After the horizontal and the vertical ends of the faces are developed as per user requirement we move on to the middle part of each and every face and design it keeping the essence of the original marble intact. Thus, we have achieved a 3 random faced and a continuous marble.

Please note that as and when we add a new face and start designing it as per user requirement, the faces already designed by us in previous steps undergo minor changes to get as close to the naturally recreated marble.

After the third face, we move on to the fourth face. As mentioned earlier we have kept a minimum of four faces in all our designs.

Now as we designed the earlier faces, we start designing the fourth face similarly. Firstly both the horizontal and the vertical ends of the fourth face are designed in such a way that you lay it next to any of the previous face as per the arrow direction, it would remain continuous joint free with any of them.

Now after that is achieved we design all the four faces simultaneously and try to achieve closest possible carpet of the recreated natural marble from where we started. Again each and every face undergoes minor changes without affecting the naturality of the recreated marble.

Thus we have achieved a marble which has multiple random faces and is still continuous.

### Advantages

The first and the foremost advantage is the user gets a very superior product. The final product looks seamless after being laid and would look like a homogeneous single piece Italian Slab only. So final product of the present invention can be used as a substitute for ITALIAN MARBLE. The extraction of Italian Marble is a very costlier and some of the natural marbles are very rare. The present invention tiles being man made, the user can produce the same marble for a long time as and when required. Laying and handling of tiles is much easier than the Italian marble. In the whole manufacturing process the manufacturer keeps in mind the environment and try using as many recyclable products and green energy as possible. So the present final product is less polluting and environment friendly. The end customer gets a better product of a budget price. Also, the end customer gets value for money in the present invention product.

Although, the invention has been described and illustrated with respect to the exemplary embodiments thereof, it should be understood by those skilled in the art that the foregoing and various other changes, omissions and additions may be made therein and thereto, without parting from the spirit and scope of the present invention.

1-7. (canceled)

8. A continuous layout random face tile and method (200), wherein said method (200) comprising:
obtaining (100) predetermined size of carpet piece;
obtaining (101) subset of original carpet piece;
wherein the subset comprises of predetermined dimensions;
creating (102) more than one faces from the subset carpet;
creating (103) design on the horizontal and vertical ends of the subset of work piece (Face A and Face B) and obtaining joint free work piece (Face A and Face B) with random faces; and
creating (104) design on the middle, or centre part of each random face,
wherein said continuous layout random face tile is the printed work piece (Face A and Face B) comprises of an indicator mark at the rear side; said designed work pieces Face A and Face B are configured uni-directionally as per an indicator mark to obtain joint free or continuous faces in the layout; said designed work pieces Face A and Face B are configured to move in horizontal as well vertical direction, irrespective of the orientation of their faces as per an indicator mark to obtain joint free a homogenous single piece layout.

9. The method (200) of printing continuous layout random phase face titles as claimed in claim 8, wherein each face of the said work piece (Face A and Face B) is designed to match continuously with face of another work piece (Face A and Face B) laid unidirectional as per the indicator mark.
